(19) United States
(12) Patent Application Publication
(10) Pub. No.: US 2013/0063864 A1
(43) Pub. Date: Mar. 14, 2013

(54) MULTI-LAYER CERAMIC ELECTRONIC COMPONENT WITH SOLDER BLOCKING LAYER

(71) Applicant: JUN-YI XIAO, Zhongshan City (CN)

(72) Inventor: JUN-YI XIAO, Zhongshan City (CN)

(73) Assignees: HON HAI PRECISION INDUSTRY CO., LTD., Tu-Cheng (TW); AMBIT MICROSYSTEMS (ZHONGSHAN) LTD., Zhongshan City (CN)

(21) Appl. No.: 13/278,187

(22) Filed: Oct. 21, 2011

(30) Foreign Application Priority Data
Sep. 9, 2011 (CN) 201120339881.1

(51) Int. Cl. H01G 4/12

(52) U.S. Cl. 361/321.2

(57) ABSTRACT

A multi-layer ceramic electronic component includes a ceramic base, a pair of exterior electrodes located on two ends of the ceramic base, respectively, an inner electrode embedded in the ceramic base, and a solder blocking layer located between the pair of the exterior electrodes and projecting from an exterior surface of the ceramic base.

### BACKGROUND

1. Technical Field

The present disclosure generally relates to multi-layer ceramic electronic component, more particularly to a multi-layer ceramic electronic component with a solder blocking layer.

2. Description of Related Art

Multi-layer ceramic electronic components, such as multi-layer ceramic chip capacitors are popularly employed in packaged modules, such as WIFI modules and radio frequency (RF) modules. A tiny gap is potentially formed between an exterior surface of the multi-layer ceramic electronic component and an encapsulation body of a packaged module after a package process of the multi-layer ceramic electronic component. The tiny gap is formed due to slipperiness of the exterior surface of the multi-layer ceramic electronic component weakening adhesion between the exterior surface and the encapsulation body. As a result, during a reflow soldering process, melted tins on two ends of the multi-layer ceramic electronic component would flow along the tiny gap under a capillary action to connect to each other, which would lead to the multi-layer ceramic electronic component being shorted.

Therefore, a need exists in the industry to overcome the described problem.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic view of a multi-layer ceramic electrical component of a first exemplary embodiment of the disclosure.

FIG. 2 is a cross-sectional view taken along line II-II of FIG. 1.

FIG. 3 is a schematic view of a multi-layer ceramic electrical component of a second exemplary embodiment of the disclosure.

FIG. 4 is a schematic view of a multi-layer ceramic electrical component of a third exemplary embodiment of the disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

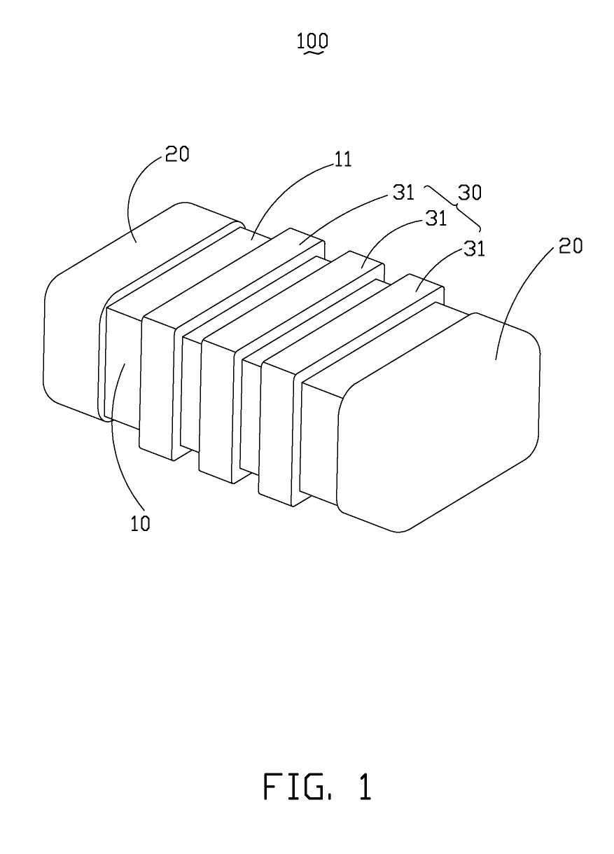

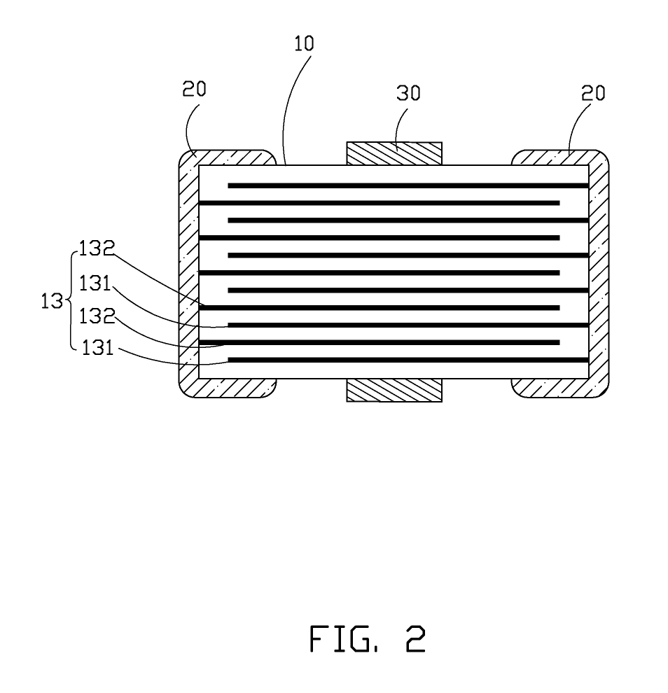

With reference to FIG. 1 and FIG. 2, a multi-layer ceramic electrical component 100 comprises a ceramic base 10 with a slippery exterior surface 11, a pair of exterior electrodes 20 located on two ends of the ceramic base 10, respectively, an inner electrode 13 embedded in the ceramic base 10 and connected to the exterior electrodes 20, and a solder blocking layer 30 located between the pair of exterior electrodes 20 and projecting from the exterior surface 11 of the ceramic base 10. In the embodiment, the solder blocking layer 30 and the exterior surface 11 of the ceramic base 10 collectively form a ladder to lower fluidity of melted tins on two ends of the ceramic base 10 during a reflow soldering process of the multi-layer ceramic electrical component 100.

The inner electrode 13 comprises a plurality of first electrodes 131 and a plurality of second electrodes 132. The first electrodes 131 and the second electrodes 132 are alternately arranged in the ceramic base 10 and connected to the pair of exterior electrodes 20, respectively. In the embodiment, the multi-layer ceramic electrical component 100 is a multi-layer ceramic capacitor (MLCC).

In the embodiment, the exterior electrode 20 is made of tin, and the solder blocking layer 30 is made of insulated material, such as plastic. During a package process of the multi-layer ceramic electrical component 100, the solder blocking layer 30 improves adhesion between the exterior surface 11 of the ceramic base 10 and an encapsulation body encapsulated onto the exterior surface 11 of the ceramic base 10, to prevent any tiny gaps from being formed between the encapsulation body and the exterior surface 11 of the ceramic base 10. Furthermore, melted tins on the two exterior electrodes 20 are blocked to flow toward each other and connect together during a reflow soldering process. That is, in the embodiment, even if a tiny gap is formed between the encapsulation body and the exterior surface 11 of the ceramic base 10 during the package process, melted tins on the two exterior electrodes 20 are prevented from flowed together during the reflow soldering process. Because the solder blocking layer 30 projecting from the exterior surface 11 of the ceramic base 10 separates the tins on the two ends of the ceramic base 10 from each other, which can prevent the tins on the two ends of the ceramic base 10 flowing together effectively and leading to short.

In the embodiment, the solder blocking layer 30 comprises a plurality of solder strips 31, and the plurality of solder strips 31 are substantially evenly spaced apart from each other. The plurality of solder strips 31 prevent the tins on the two ends of the ceramic base 10 flowing together effectively.

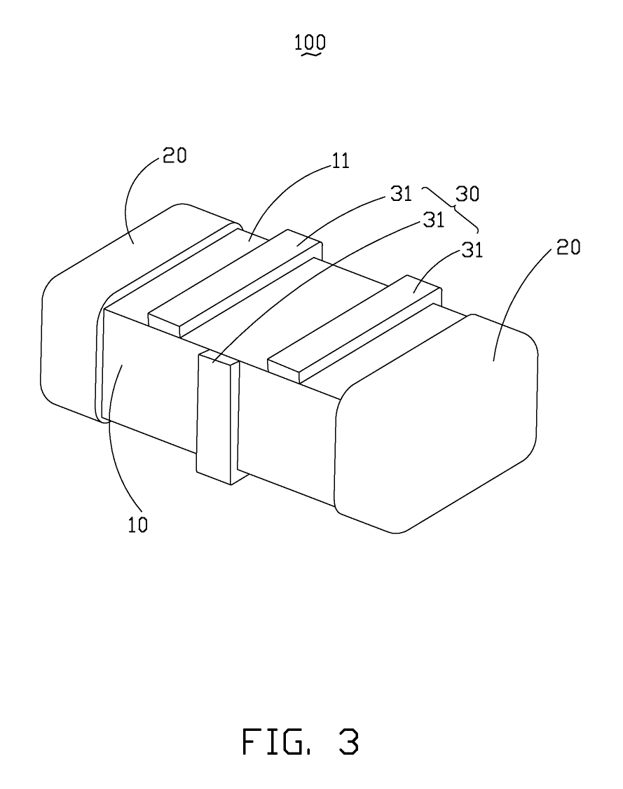

With reference of FIG. 3, in other embodiment, the plurality of solder strips 31 are alternately arranged around a half circle of the exterior surface 11 of the ceramic base 10, which lead to saving materials of the solder blocking layer 30.

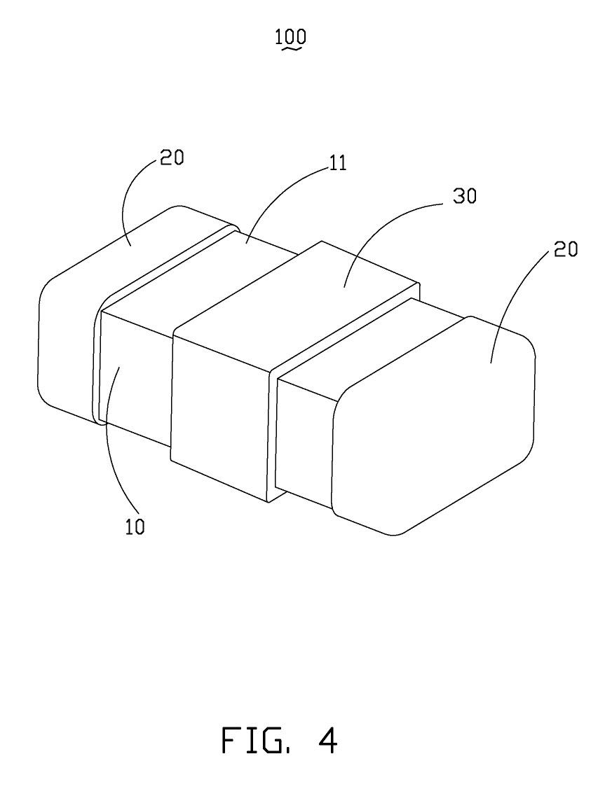

Referring to FIG. 4, in the embodiment, the solder blocking layer 30 is substantially in a shape of a square surrounding the exterior surface of the ceramic base 10. In other embodiment, the solder blocking layer 30 can be in a shape of rhombus, or in a shape of a circle.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. A multi-layer ceramic electronic component, comprising a ceramic base, a pair of exterior electrodes located on two ends of the ceramic base, and a inner electrode embedded in the ceramic base, wherein the multi-layer ceramic electronic component comprises a solder blocking layer located between the pair of the exterior electrodes and projecting from an exterior surface of the ceramic base.

2. The multi-layer ceramic electronic component as claimed in claim 1, wherein the solder blocking layer comprises a plurality of solder strips.

3. The multi-layer ceramic electronic component as claimed in claim 2, wherein the plurality of solder strips are substantially evenly spaced apart from each other.

4. The multi-layer ceramic electronic component as claimed in claim 2, wherein the plurality of solder strips are alternately arranged around a half circle of the exterior surface of the ceramic base.

5. The multi-layer ceramic electronic component as claimed in claim 1, wherein the solder blocking layer is substantially in a shape of a square surrounding the exterior surface of the ceramic base.
